(19) United States
(12) Patent Application Publication
(10) Pub. No.: US 2007/0132782 A1
(43) Pub. Date: Jun. 14, 2007

(54) Method for processing graphics data by a graphic controller

(76) Inventors: Junko Suzaki, Kanagawa (JP); Satoshi Ishii, Kanagawa (JP); Takayuki Shirakawa, Osaka (JP)

Correspondence Address: MCDERMOTT WILL & EMERY LLP, 600 13TH STREET, N.W., WASHINGTON, DC, 20005-3096, US

(21) Appl. No.: 11/604,870

(22) Filed: Nov. 28, 2006

(30) Foreign Application Priority Data
Nov. 30, 2005 (JP) 2005-346677

(51) Int. Cl. G09G 5/00

(52) U.S. Cl. 345/629

(57) ABSTRACT

In a drawing processing apparatus and a drawing processing method for superposing a plurality of graphics present on the same plane, a data format is previously extracted in a data format extraction control section. A write data extracting section converts write data from a DDA section into the extracted data format. A read data extracting section converts read data from a drawing frame memory into the extracted data format. A data comparing section compares the data format-converted write data from the write data extracting section with the data format-converted read data from the read data extracting section. When the two pieces of data are the same, a drawing output section omits a process of writing the write data form the DDA section into the drawing frame memory.

### CROSS REFERENCE TO RELATED APPLICATIONS

This Non-provisional application claims priority under 35 U.S.C. §119(a) on Patent Application No. 2005-346677 filed in Japan on Nov. 30, 2005, the entire contents of which are hereby incorporated by reference.

### BACKGROUND OF THE INVENTION

1. Field of the Invention

The present invention relates to an image processing method with which a plurality of graphics are superposed and drawn in computer graphics.

2. Description of the Related Art

In recent years, computer graphics has been widely used in video games, car navigation systems, and the like. In image processing apparatuses used in these, it is often that a number of characters, graphics or the like are superposed, but it is not often that graphics are simply separately disposed on plain background.

In an image processing apparatus which generates drawing data in accordance with a drawing command, generated image data is converted into data suitable for the drawing command, and is drawn into a drawing frame memory. Most drawing data used in such an image processing apparatus is generated based on a drawing command for image data designated by an application. When drawing data is drawn into a drawing frame memory in accordance with the drawing command, a write process may be omitted, depending on a relationship between drawing data for an image to be drawn and drawing data already drawn in the drawing frame memory. In this case, processing speed can be increased by using a technique which can omit a drawing process.

As a conventional example of such a drawing process, there is a known technique described in Japanese Unexamined Patent Application Publication No. 5-266177. According to the technique described in the publication, as illustrated in FIG. 13, read data 124 obtained from a drawing frame memory 118 by a read process, and write data 123 are subjected to a logical operation in a computation section 1104. Data obtained by the logical operation process is compared with the read data 124 in a comparison section 1105. When it is detected that the two pieces of data are the same, the subsequent write process with respect to the drawing frame memory 118 is omitted, thereby reducing a processing amount.

However, actual image data have various data formats. Therefore, if it is determined whether or not pieces of data are completely the same as in the conventional technique, a write process with respect to the drawing frame memory 118 may not be omitted. For example, in the conventional method, when only a portion of drawing data is used for matching determination, data matching determination is performed while necessary data and unnecessary data coexist. In this case, matching determination is not correctly performed. As a result, a drawing process is executed even with respect to data which does not need to be drawn, i.e., an unnecessary access process is generated.

### SUMMARY OF THE INVENTION

An object of the present invention is to correctly determine whether or not a write process can be omitted with respect to pieces of drawing data having various data formats in a drawing process, thereby reducing a useless drawing process to achieve a high-speed drawing process.

To achieve the object, in the present invention, two pieces of data to be compared (i.e., write data to be drawn, and read data in a drawing frame memory which has the same coordinates as those of a drawing position of the write data) are converted into the same predetermined appropriate data format before being compared.

The present invention provides an image processing method for generating graphic drawing data in accordance with a graphic drawing command for image data and storing the graphic drawing data into a drawing frame memory, comprising a data format extracting step of extracting a data format suitable for the graphic drawing data to be generated, depending on a graphic drawing command for a graphic to be drawn, a conversion step of converting write data to be drawn, and read data in the drawing frame memory corresponding to a graphic position of the write data into the extracted data format, and a drawing omission determining step of determining whether or not the write data and read data converted by the conversion step are the same, and based on the result of the matching determination, determining whether or not a process of writing the write data into the drawing frame memory can be omitted.

In an example of the image processing method of the present invention, the data format extracting step extracts a data format suitable for the graphic drawing data to be generated, depending on a drawing attribute, a drawing color format or the like designated by a graphic drawing command for a graphic to be drawn.

In an example of the image processing method of the present invention, the data format extracting step extracts, as the data format, a data format having a drawing attribute which employs only cc data included in drawing data, or a data format having a drawing attribute which employs data other than the α data.

The present invention provides an image processing method for generating graphic drawing data in accordance with a graphic drawing command for image data and storing the graphic drawing data into a drawing frame memory, comprising a data format extracting step of extracting a data format suitable for the graphic drawing data to be generated, depending on a graphic drawing command for a graphic to be drawn, a conversion step of converting write data to be drawn, and read data in the drawing frame memory corresponding to a graphic position of the write data into the extracted data format, and a drawing omission determining step of determining whether or not a difference between the write data and read data converted by the conversion step is within a predetermined range, and based on the result of the determination, determining whether or not a process of writing the write data into the drawing frame memory can be omitted.

The present invention provides an image processing method for generating graphic drawing data in accordance with a graphic drawing command for image data and storing the graphic drawing data into a drawing frame memory. Drawing data to be drawn includes α data, and a predetermined bit of the α data is used as a sequence identification number. The method comprises a drawing omission determining step of, when two or more graphics to be drawn are superposed and drawn on the same plane, comparing a sequence identification number of a pixel to be drawn with a sequence identification number in the drawing frame memory corresponding to a graphic position of the pixel, and based on the result of the comparison, determining whether or not a process of writing data of the pixel into the drawing frame memory can be omitted.

In an example of the image processing method of the present invention, when two or more graphics to be drawn are superposed on the same plane, and the graphics are rearranged in order of vertical position with the lowest first before being superposed and drawn, the drawing omission determining step determines whether or not two predetermined graphics overlap, and when the result of the determination shows that the two graphics overlap, determines that one of the graphics can be omitted, based on the sequence identification numbers.

The present invention provides an image processing method for receiving a command list for image data, generating graphic drawing data in accordance with a graphic drawing command in the command list, and storing the graphic drawing data into a drawing frame memory. The command list defines a start command and an end command, and graphics generated by two or more graphic drawing commands provided between the start and end commands are defined to be present on the same plane. α data included in drawing data for the graphics generated by the graphic drawing commands between the start and end commands is used as sequence identification numbers indicating a graphic superposition sequence. The method comprises a control step of processing the command list, a write data extracting step of extracting a sequence identification number of a pixel of a graphic to be drawn which is generated by the graphic drawing command, a read data extracting step of extracting a sequence identification number in the drawing frame memory having the same coordinates as those of the pixel of the graphics to be drawn, and a drawing omission determining step of comparing the two extracted sequence identification numbers, and depending on the result of the comparison, determining whether or not a write process with respect to the drawing frame memory can be omitted.

The present invention provides an image processing method for receiving a command list for image data, generating graphic drawing data in accordance with a graphic drawing command in the command list, and storing the graphic drawing data into a drawing frame memory. The command list defines a start command and an end command, and graphics generated by two or more graphic drawing commands provided between the start and end commands are defined to be present on the same plane. α data included in drawing data for the graphics generated by the graphic drawing commands between the start and end commands is used as sequence identification numbers indicating a graphic superposition sequence. The method comprises a control step of processing the command list to rearrange the two or more graphic drawing commands in order of vertical position with the lowest or highest first, based on the sequence identification numbers of the two or more graphic drawing commands between the start and end commands, and a drawing processing step of drawing the graphics based on the graphic drawing commands in accordance with the rearranged sequence of the graphic drawing commands.

In an example of the image processing method of the present invention, the control step extracts a graphic drawing command located at the highest position, and the drawing processing step draws only a graphic based on the graphic drawing command located at the highest position.

The present invention provides an image processing method for generating graphic drawing data in accordance with a graphic drawing command for image data and storing the graphic drawing data into a drawing frame memory, comprising a control step of processing the graphic drawing command when graphics are superposed and drawn, the graphic drawing command having bits of a data included in drawing data as a plane identification number and a sequence identification number, a write data extracting step of extracting a plane identification number of a pixel of a graphic generated in accordance with the graphic drawing command processed in the control step, a read data extracting step of extracting a plane identification number in the drawing frame memory having the same coordinates as those of the pixel of the generated graphic, and a data comparing step of comparing the two extracted plane identification numbers, and depending on the result of the comparison, determining whether or not the two pixels having the two plane identification numbers are of graphics present on the same plane.

In an example of the image processing method of the present invention, the method comprises a write data extracting step of extracting a sequence identification number of a graphic determined to be present on the same plane, a read data extracting step of extracting a sequence identification number in the drawing frame memory having the same coordinates as those of the graphic determined to be present on the same plane, and a drawing omission determining step of comparing the two extracted sequence identification numbers, and depending on the result of the comparison, determining whether or not a write process with respect to the drawing frame memory can be omitted.

In an example of the image processing method of the present invention, the drawing omission determining step determines whether or not generation of drawing data is invariably performed with respect to the drawing frame memory which has not been drawn, and when the result of the determination is positive, omits reading of data from the drawing frame memory.

The present invention provides a program for causing a computer to a procedure for the drawing processing method.

The present invention provides a computer readable recording medium storing the program.

As described above, according to the present invention, a data format suitable for a drawing output data format, such as a drawing command, a drawing attribute, a drawing color format, or the like, is previously extracted in the data format extracting circuit, taking into consideration a signal having an influence on the drawing output data format. When write data to be drawn is compared with read data in the drawing frame memory which has the same coordinates as those of the write data, the two pieces of data are compared after being converted into the extracted data format. Therefore, required data portions can be compared, so that a drawing process is not performed with respect to unnecessary write data, which is different from the conventional art. Thus, an unnecessary write process or a useless memory access is reduced. In addition, data which fits a drawing command can be freely extracted, thereby making it possible to suppress an increase in a circuit portion for data comparison, resulting in a small circuit and a higher-speed drawing process.

Particularly, in the present invention, when a difference between write data to be written and read data in the drawing frame memory is within a predetermined small range, a drawing process is omitted, thereby making it possible to achieve an even higher-speed drawing process.

Also, in the present invention, partial data, such as α data (data indicating a transmittance of each pixel of a graphic) is used as a sequence identification number (including a display priority) of a graphic irrespective of a content of data, such as a color, a bitmap, a texture, a binary pattern, or the like. Therefore, a plurality of graphics present on the same plane can be correctly superposed and drawn. Specifically, a reference plane is defined, and a number is previously given to a graphic with reference to the reference plane. The magnitude of a number already drawn in the drawing frame memory is compared with the magnitude of a number to be drawn, so that a vertical relationship between graphics to be superposed is known. Therefore, only a graphic located at an upper position can be drawn, thereby making it possible to reliably omit a process of drawing write data which does not need to be drawn.

In addition, according to the present invention, a start command and an end command are prepared. A plurality of graphics between the two commands are assumed to be present on the same plane. Bits of a data are used as a sequence identification number. Therefore, a plurality of graphics can be correctly superposed only by comparing the sequence identification number of write data to be drawn with the sequence identification number of read data in the drawing frame memory having the same coordinates as those of the write data. Therefore, a process of drawing unnecessary write data is not executed, thereby reducing an unnecessary write process or a useless memory access, which is different from the conventional art.

In addition, according to the present invention, when two or more graphics to be drawn are superposed and drawn, bit values of α data in image data are used as a plane identification number and a sequence identification number. By comparing the plane identification number of a pixel to be superposed and drawn with a plane identification number in the drawing frame memory having the same coordinates as those of the pixel, it is possible to determine whether or not graphics are present on the same plane.

### BRIEF DESCRIPTION OF THE DRAWINGS

FIG. 1 is a block diagram illustrating a configuration of a drawing processing apparatus according to a first example of the present invention.

FIG. 2 is a flowchart of a drawing processing method of the first example.

FIG. 3 is a block diagram illustrating a configuration of a drawing processing apparatus according to a second example of the present invention.

FIG. 4 is a flowchart of a drawing processing method of the second example.

FIG. 5 is a diagram illustrating a drawing example in which graphics are superposed using sequence identification numbers in a drawing processing apparatus according to a third example of the present invention.

FIG. 6 is a diagram illustrating an outline of drawing commands in the drawing processing apparatus of the third example.

FIG. 7 is a diagram illustrating an example in which a sequence identification number is assigned to bits of an α value in the drawing processing apparatus of the third example.

FIG. 8 is a flowchart when a graphic and a pixel of a drawing frame memory are compared, where a sequence identification number is assigned to bits of an α value, in the drawing processing apparatus of the third example.

FIG. 9 is a flowchart when graphics are previously rearranged from the lowest in a control section, where a sequence identification number is assigned to bits of an α value, in the drawing processing apparatus of the third example.

FIG. 10 is a flowchart when a graphic closest to the user is previously extracted in a control section, where a sequence identification number is assigned to bits of an α value, in the drawing processing apparatus of the third example.

FIG. 11 is a diagram illustrating an example in which a sequence identification number and a plane identification number are assigned to bits of an α value, in the drawing processing apparatus of the third example.

FIG. 12 is a flowchart when a graphic and a pixel of a drawing frame memory are compared, where a sequence identification number and a plane identification number are assigned to bits of an α value, in the drawing processing apparatus of the third example.

FIG. 13 is a block diagram illustrating a configuration of a conventional drawing processing apparatus.

### DETAILED DESCRIPTION OF THE PREFERRED EMBODIMENTS

Hereinafter, preferred examples of the present invention will be described with reference to the accompanying drawings.

### FIRST EXAMPLE

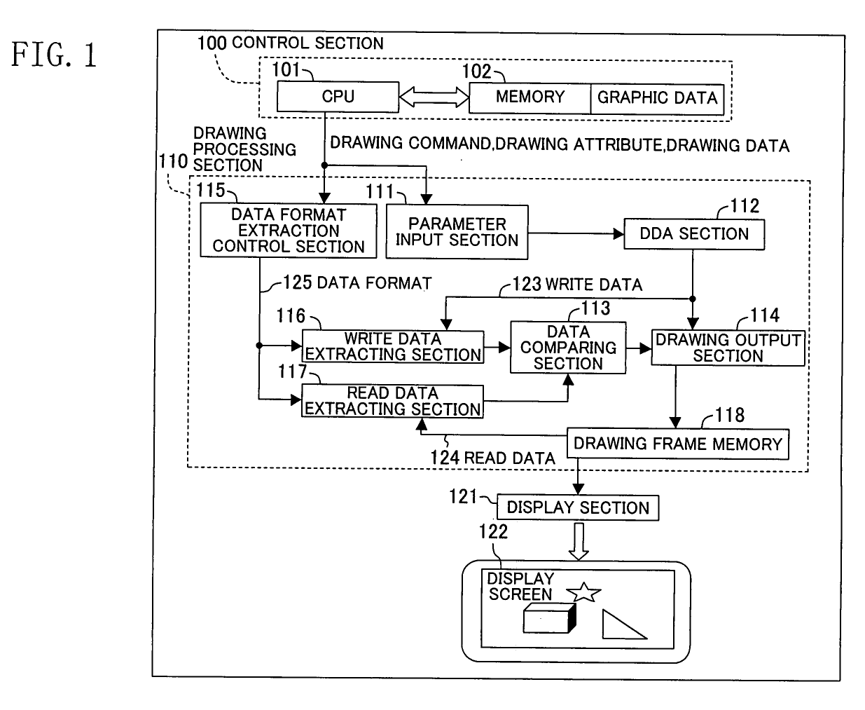

FIG. 1 is a block diagram illustrating a configuration of a drawing processing apparatus according to a first example of the present invention.

In FIG. 1, a control section 100, a drawing processing section 110, a display section 121, and a display screen 122 are interconnected to construct a drawing process system.

In the control section 100, in accordance with a drawing command input from an application, the CPU 101 interprets the drawing command into a form suitable for the succeeding drawing processing section 110, to generate parameters including the drawing command, and a drawing attribute and a drawing color format included in the drawing command, and outputs the parameters to a parameter input section 111 and a data format extraction control section 115.

The drawing processing section 110 comprises the parameter input section 111, a DDA section 112, a data comparing section 113, a drawing output section 114, the data format extraction control section 115, a write data extracting section 116, a read data extracting section 117, and the drawing frame memory 118.

The data format extraction control section (data format extracting circuit) 115 uses the parameters including the drawing command, the drawing attribute, and the drawing color format, to extract a data format 125 optimal for drawing output data.

Also, in the drawing processing section 110, the write data extracting section (conversion circuit) 116 converts the write data 123 from the DDA section 112 into the data format 125 extracted by the data format extraction control section 115, and the read data extracting section (conversion circuit) 117 converts the data 124 read from the drawing frame memory 118 into the data format 125 extracted by the data format extraction control section 115.

Further, in the drawing processing section 110, the data comparing section (drawing omission determining circuit) 113 determines whether or not the two pieces of data extracted by the write data extracting section 116 and the read data extracting section 117 are the same (matching determination), and outputs to the drawing output section 114 a signal indicating whether or not the next write process can be omitted. Only when a write process is required, the drawing output section 114 draws write data from the DDA section 112 into the drawing frame memory 118.

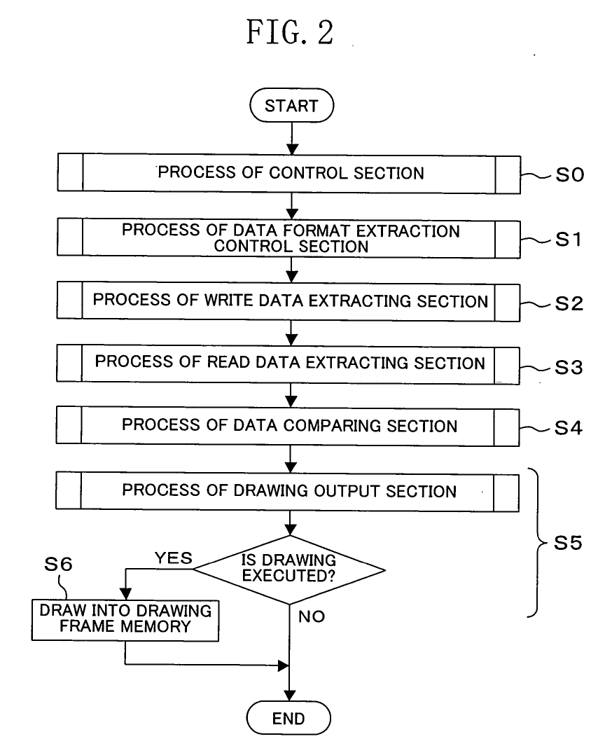

FIG. 2 illustrates a drawing processing method for executing these processes. In FIG. 2, in step S0, the control section 100 provides a parameter which is interpreted in a form suitable for the succeeding drawing processing section 110, in accordance with a drawing command input from an application. Thereafter, in step S1, the data format extraction control section 115 extracts the data format 125 based on the parameter input from the control section 100. Thereafter, in steps S2 and S3, the write data extracting section 116 extracts the write data 123, and the read data extracting section 117 extracts the read data 124 from the drawing frame memory 118, and the sections convert these pieces of data into the data format 125 extracted in step S0. In step S4, it is determined whether or not the two pieces of data converted into the data format are the same, to determine whether or not a drawing process can be omitted, and a signal indicating whether or not a drawing process can be omitted is input to the drawing output section 114. In step S5, when a drawing process can be omitted, the drawing output section 114 ends the process. When a drawing process is required, drawing is performed with respect to the drawing frame memory 118 in step S6 before the process is ended.

Next, an operation of this example will be described. There are many drawing data formats. For example, a graphic to be drawn may have a data format of 16-bit depth (3-bit α data; 4-bit R data; 5-bit G data; and 4-bit B data), and a drawing attribute which does not use α data. This case will be described below.

Initially, based on the parameter which has been interpreted into a suitable form by the CPU 101, the data format 125 of a graphic to be drawn by the data format extraction control section 115 of the drawing processing section 110 is extracted, and the extracted data format 125 is input to the write data extracting section 116 and the read data extracting section 117. The write data extracting section 116 converts the write data 123 into the designated data format 125, and extracts required data R, G and B. Similarly, the read data extracting section 117 reads data having the same address as a position of the graphic to be drawn, from the drawing frame memory 118, and extracts data R, G and B converted into the designated data format 125. A method used for extracting data is determined, depending on a drawing command, a drawing attribute, a drawing color format, or the like, and therefore, may be arbitrarily designated.

Next, the data comparing section 113 compares the extracted write data 123 and read data 124 to determine whether or not the two pieces of data are the same. When the two pieces of data are the same, it is determined that drawing is not required, and write omission information is output to the drawing output section 114, so that a write process with respect to the drawing frame memory 118 can be omitted. Thereby, an unnecessary write process and a useless memory access can be reduced, resulting in a high-speed drawing process.

Data suited to a drawing command can be freely extracted, so that only necessary data being actually used can be compared. For example, when a command attribute employs only α data, the data comparing section 113 can be implemented using only a circuit for comparing α data, thereby making it possible to suppress an increase in circuit. Thereby, a higher-speed drawing process can be achieved using a smaller circuit.

Although the example employing the drawing attribute has been described, the present invention is not limited to this. It is possible to extract a data format, depending on a drawing output data format, such as a drawing command, image data, or the like, and it is also possible to freely design the extraction method. In addition, there is not limitation on the designated bit width and the contents of data, and the process can be preformed even if any one or any combination of α, R, G and B is used. When it is previously known that generation of drawing data is invariably performed with respect to a drawing frame memory which has not been drawn, reading of data from the drawing frame memory 118 may be omitted, and write data may be drawn.

### SECOND EXAMPLE

Next, a drawing processing apparatus and a drawing processing method according to a second example of the present invention will be described.

To achieve a higher-speed drawing process, the fact that human eyes are not very sensitive to chroma is utilized. Humans have difficulty in perceiving a slight difference in color. If the data comparing section 113 determines that write data and read data are different from each other, but a difference between them is within a predetermined range in which the difference cannot be perceived, it is determined that a write process can be omitted. When it is determined whether or not a write process can be omitted, comparison precision is adjusted by providing a predetermined tolerance range. If a difference resulting from comparison is within the tolerance range, the next write process can be omitted. Thereby, useless memory access can be further reduced, thereby making it possible to obtain a high-speed drawing process. Note that the tolerance range is externally provided.

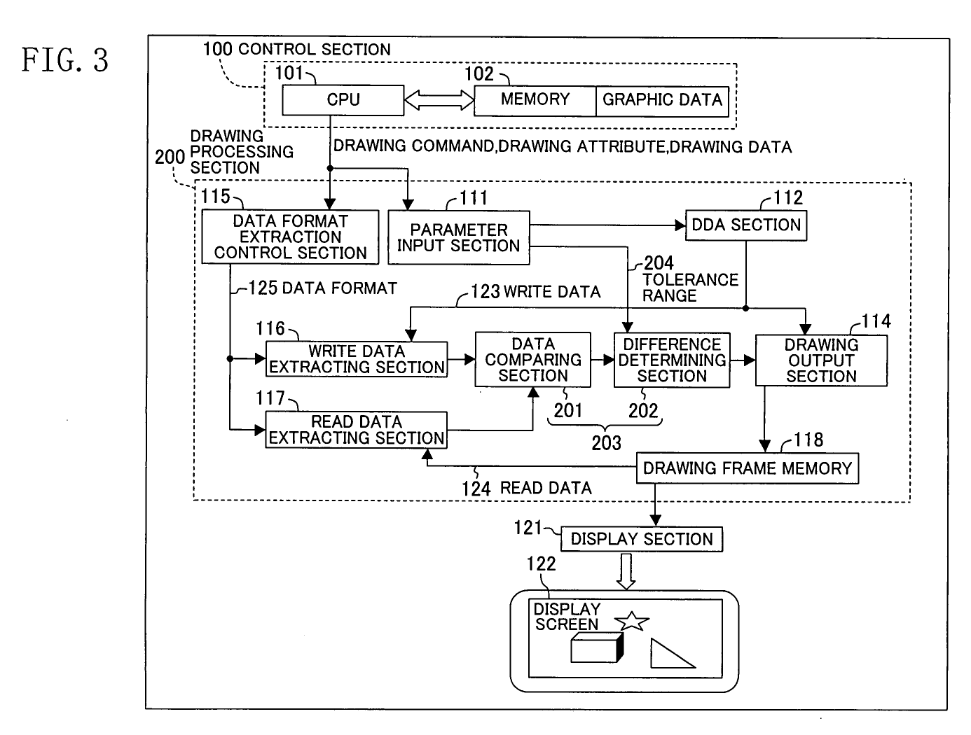

FIG. 3 is a block diagram illustrating a configuration of a drawing processing apparatus according to this example. In FIG. 3, the configuration of the second example is the same as that of the first example, except for a data comparing section 201 and a difference determining section 202 in a drawing processing section 200.

In FIG. 3, the data comparing section 201 calculates a difference between write data and read data which have been converted into the data format 125 extracted by the data format extraction control section 115, and outputs the difference to the difference determining section 202. The difference determining section 202 determines whether or not the difference is within a predetermined tolerance range 204 which is previously provided, and when the difference is within the tolerance range 204, determines that a write process with respect to the drawing frame memory 118 can be omitted, and outputs a signal indicating the determination result to the drawing output section 114. The data comparing section 201 and the difference determining section 202 constitute a drawing omission determining circuit 203. The drawing output section 114 receives the signal which is from the difference determining section 202 and indicates whether or not a write process can be omitted, and draws write data from the DDA section 112 into the drawing frame memory 118 only when a write process is required.

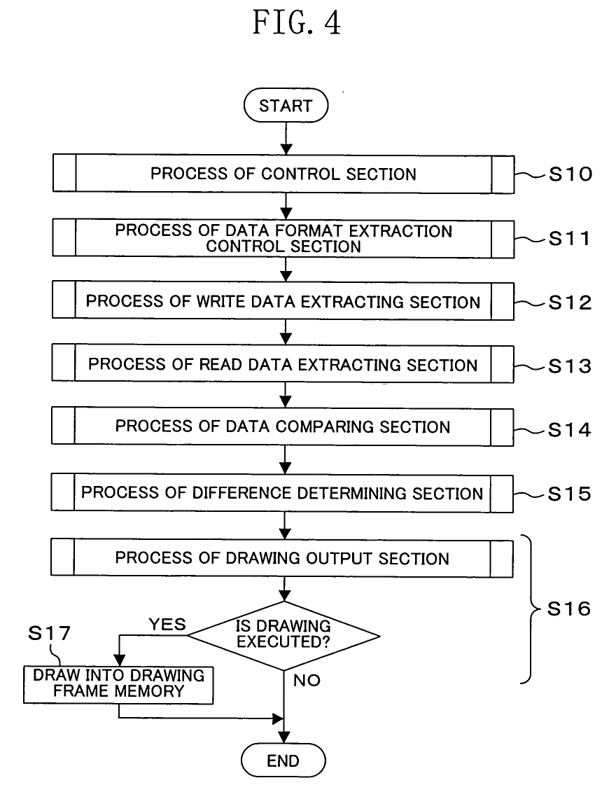

FIG. 4 illustrates a method for executing the above-described process. The method of FIG. 4 is the same as that of FIG. 2, except for processes in steps S14 and S15.

In FIG. 4, the write data 123 and the read data 124 are converted into the data format 125 extracted in step S11, in step S12 and step S13, respectively. Next, in step S14, a difference in the converted write data and read data is calculated, and the difference is output to the difference determining section 202. In step S15, it is determined whether or not the difference is within the predetermined tolerance range 204, and a signal indicating whether or not a drawing process can be omitted is output to the drawing output section 114. In step S16, the drawing output section 114, when a drawing process can be omitted, ends drawing, and when a drawing process is required, performs drawing with respect to the drawing frame memory 118 in step S17 before the process is ended.

Next, an operation of this example will be described. For example, it is assumed that the data format of a graphic to be drawn is that R data is 8-bit data. It is now assumed that extracted write data is “11111110”, extracted read data is “11111101”, and an externally provided tolerance range 204 is “00000010”. The values are all represented by 8-bit binary numbers. Any data extracting method may be designated, and there is not limitation on a method for providing the tolerance range.

The data comparing section 201 outputs a difference “00000001” between the write data and the read data converted into the data format 125 to the difference determining section 202. Since the difference “00000001” is within the tolerance range “00000010”, the difference determining section 202 determines that a write process with respect to the drawing frame memory 118 can be omitted. As a result, the drawing output section 114 can omit the write process with respect to the drawing frame memory 118. Thereby, even when write data and read data are different from each other, but a difference between them is small, a write process can also be removed, resulting in a higher-speed drawing process. When an even higher speed is required, the tolerance range may be set to be wider. When higher correctness of drawing is required, the tolerance range may be set to be narrower.

### THIRD EXAMPLE

Next, a drawing processing apparatus and a drawing processing method according to a third example of the present invention will be described.

There is not limitation on the contents of data used in the data comparing section 113 of FIG. 1. For example, a part of α data as well as a color, a bitmap, a texture, a binary source, or the like, can be used as a sequence identification number or a display priority of a graphic.

It is now assumed that a data is used as a sequence identification number. A plane is defined as a reference, and each graphic to be drawn on the plane is assigned a sequence identification number. The sequence identification number of a graphic which has already been drawn in the drawing frame memory 118 is compared with the sequence identification number of a graphic which is to be drawn in terms of magnitude, thereby making it possible to determine a vertical relationship between positions of the graphics. Therefore, when the graphics are superposed, only the graphic that is located at the highest position can be drawn.

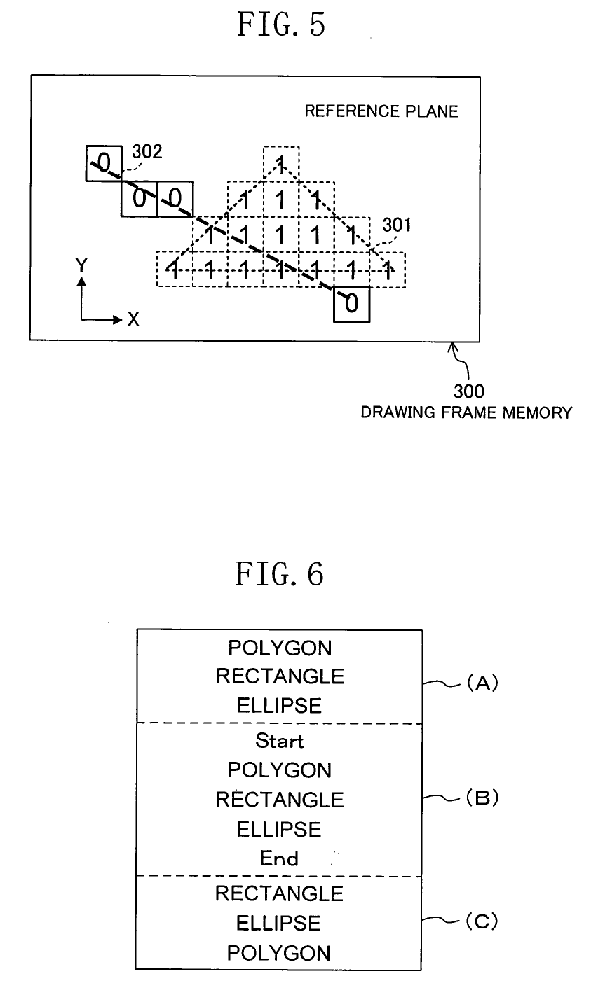

For example, it is here assumed that two graphics are superposed on the same plane. FIG. 5 illustrates the case where a straight line 302 is newly overwritten on a triangle 301 which has already been drawn in a drawing frame memory 300. In this case, the larger the sequence identification number, the higher the display priority, i.e., the higher the position of a graphic. A numeric shown in each pixel is a sequence identification number of a graphic, for which α data is used. The sequence identification numbers of pixels of the line segment 302 which is to be drawn are compared with sequence identification numbers in the drawing frame memory 300 having the same coordinates as those of the line segment 302 to be drawn in terms of magnitude, and a color value having a larger value is drawn. Thus, of graphics on the same plane, drawing processes for unnecessary graphics other than a graphic provided at the highest position are omitted, resulting in a high-speed drawing process. In general, α data has a smaller data amount than that of color data, so that a smaller comparison circuit is required, thereby making it possible to suppress an increase in circuit and correctly superposing graphics on the same plane.

In addition, comparison and determination can be performed using an amount of data depending on the number of graphics to be drawn. For example, it is here assumed that X-bit data is used as sequence identification numbers. In this case, the number of graphics which can be superposed is 2 to the power of X. By setting an appropriate data mount X as the number of graphics to be drawn, a sufficient number of graphics can be superposed and drawn using an optimum data amount. Thus, by extracting data, depending on the number of graphics to be superposed, the data comparing section 113 can be configured with a small circuit scale, thereby making it possible to reduce the circuit scale.

Although the case where the sequence identification numbers of graphics are provided as data has been described, the present invention is not limited to this. Data may represent any type of value. Data to be compared may be extracted, and subjected to matching determination or magnitude determination, depending on the value.

Next, the case where a plurality of graphics are drawn on the same plane using a small circuit and with high speed, will be described.

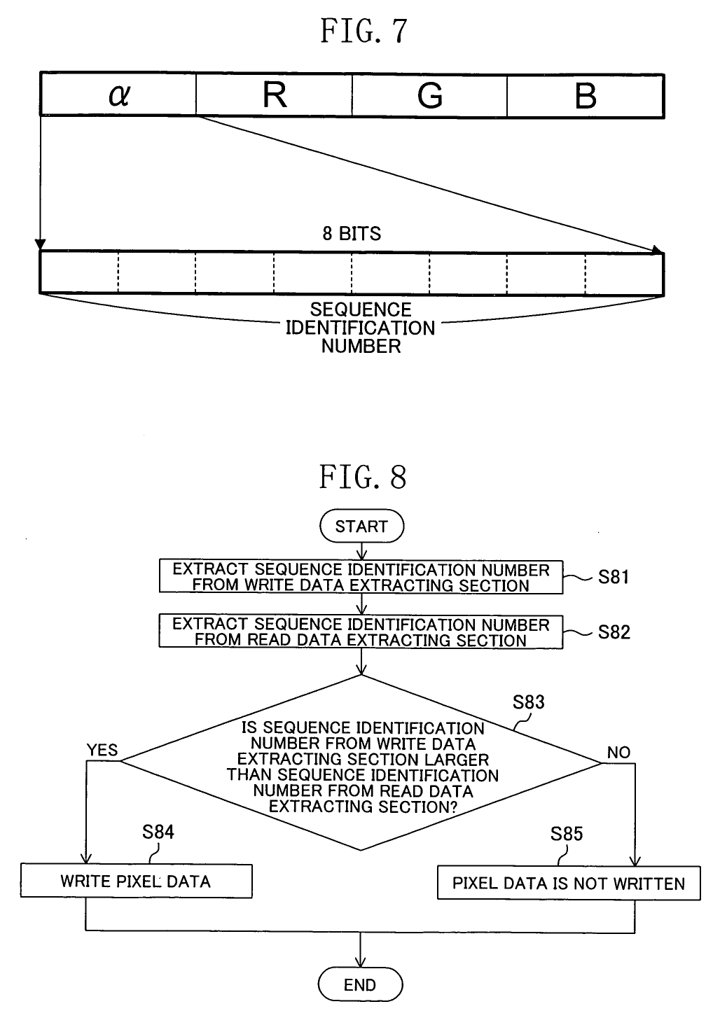

For example, commands Start and End are prepared using software in the control section 100, and it is defined that a plurality of graphics therebetween are present on the same plane. For example, as illustrated in FIG. 6, a command list is prepared using the software. Here, for drawing commands POLYGON, RECTANGLE and ELLIPSE as illustrated in (A) or (C) are defined as not being present on the same plane. POLYGON, RECTANGLE, and ELLIPSE provided between the two commands Start and End as illustrated in (B) are defined as being present on the same plane. By using bits of α data as identification numbers indicating a sequence of superposition of a plurality of graphics between the two commands Start and End, the graphics can be correctly overwritten and drawn. For example, in FIG. 7, by providing an a value having a 8-bit data format, 256 (2 to the power of 8) sequence identification numbers are provided.

FIG. 8 is a flowchart when graphics indicated by drawing commands having sequence identification numbers are superposed by comparing one pixel of each graphic. Initially, in step S81, a sequence identification number is extracted from the write data 123 by the write data extracting section 116. Next, in step S82, a sequence identification number is extracted from the read data 124 read from the drawing frame memory 118 by the read data extracting section 117. In step S83, when the sequence identification number extracted from the write data 123 is larger than the sequence identification number from the read data 124, a pixel is written into the drawing frame memory 118 in step S84. Conversely, when the sequence identification number extracted from the write data 123 is smaller than the sequence identification number from the read data 124, a write process with respect to the drawing frame memory 118 is omitted in step S85.

Note that a condition of step S83 under which a pixel is written into the drawing frame memory 118, may be that the data of the write data extracting section 116 is smaller than the data of the read data extracting section 117.

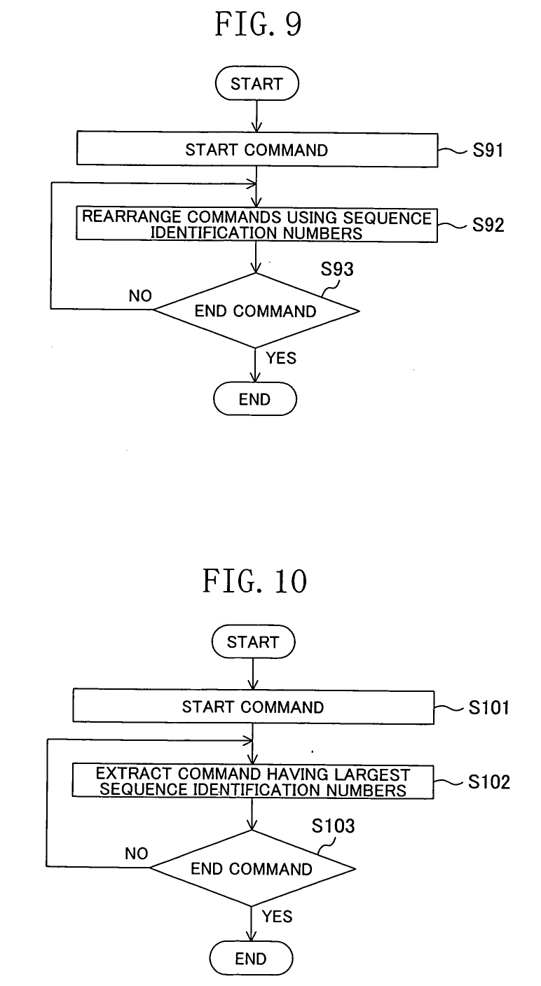

FIG. 9 is a flowchart when a plurality of drawing commands between the two commands Start and End are rearranged by the control section 100. In FIG. 9, when the command Start is detected in step S91, the drawing commands are rearranged in order of sequence identification number (largest first) in step S92. Thereafter, in step S93, the command End is detected and the rearrangement process is completed. Thereby, data comparison is no longer required in the drawing processing section 110, resulting in a smaller circuit. Note that, in step S92, even when the drawing commands are previously rearranged in order of sequence identification number (smallest first), data comparison is no longer required in the drawing processing section 110.

FIG. 10 is a flowchart when a drawing command which is to be located at the highest position when sequence identification numbers are superposed in the control section 100 is extracted from a plurality of drawing commands between the two commands Start and End. In FIG. 10, when the command Start is detected in step S101, a drawing command having a largest sequence identification number is selected in step S102. Thereafter, when the command End is detected in step S103, the selection process is completed. Thereby, data comparison is no longer required in the drawing processing section 110, and in addition, an output to the drawing output section 114 is required only one time, resulting in high speed. Note that, even when a smallest drawing command is extracted in step S102, an output to the drawing output section 114 is required only one time, resulting in high speed. This method is effective when an extracted drawing command has a larger area than those of other drawing commands.

However, in the case of the method in which the two commands Start and End are used and all α values are used as sequence identification numbers, there is a constraint that substantially only one plane can be designated.

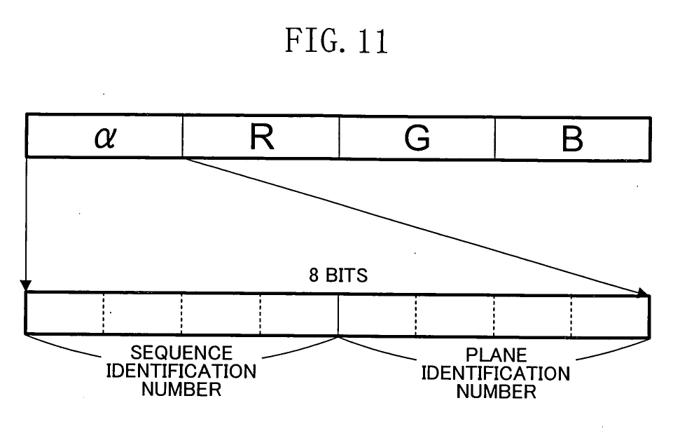

Next, it is assumed that a plane identification number and a sequence identification number are included in an a value. For example, as illustrated in FIG. 11, an a value has a 8-bit data format, and the upper 4 bits are allocated for a sequence identification number, and the lower 4 bits are allocated for a plane identification number. By using this method, 16 (2 to the power of 4) planes can be designated. Also, a maximum of 16 (2 to the power of 4) sequence identification numbers can be designated for each plane. Note that a plane identification number and a sequence identification number can be assigned to bits indicating an α value in any manner.

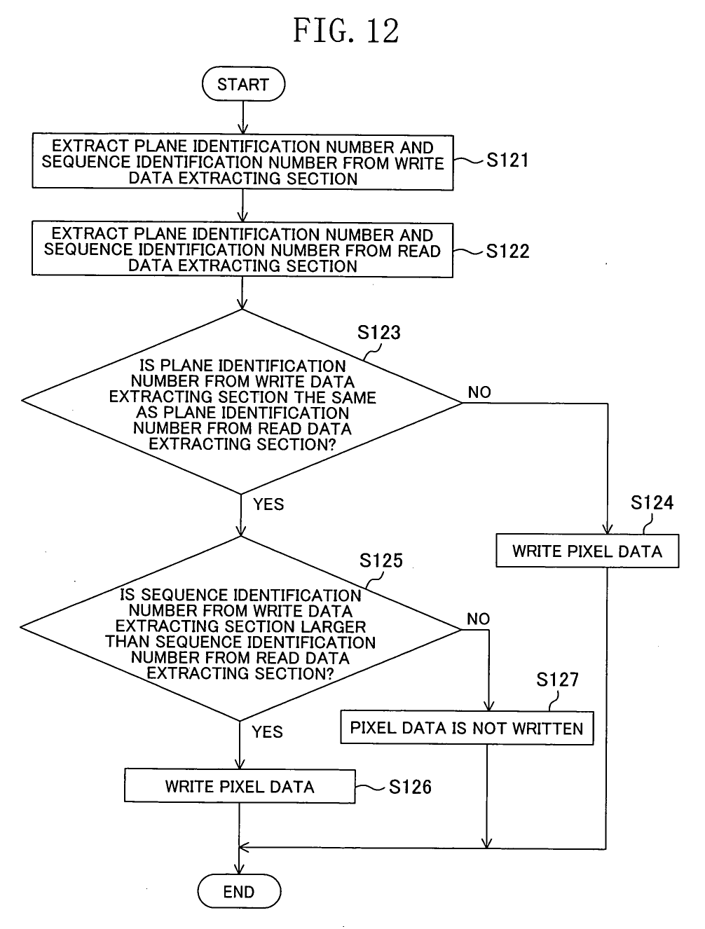

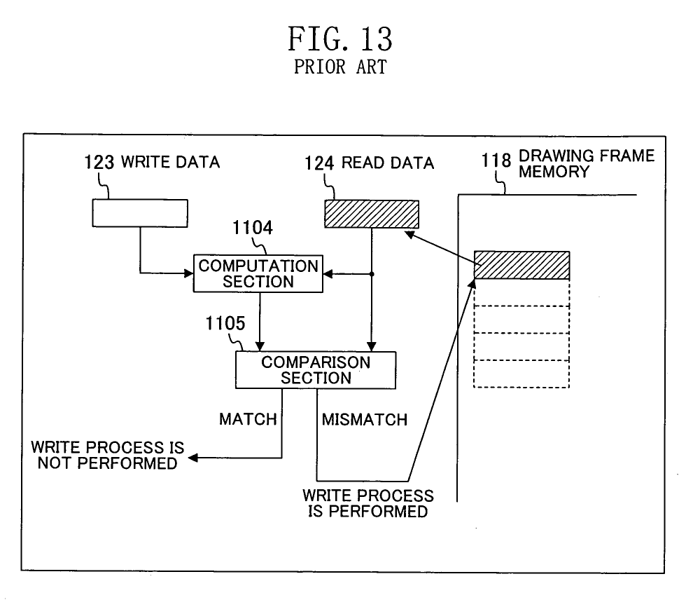

FIG. 12 is a flowchart when one pixel of each graphic indicated by a drawing command holding a plane identification number and a sequence identification number is compared before superposition is performed.

In FIG. 12, in step S121, the write data extracting section 116 extracts a plane identification number and a sequence identification number from the write data 123. Next, in step S122, the read data extracting section 117 extracts a plane identification number and a sequence identification number from the read data 124 read from the drawing frame memory 118.

Thereafter, in step S123, the data comparing section 113 compares the plane identification number extracted from the write data 123 with the plane identification number extracted from the read data 124. When the two numbers are different from each other, pixel data is written into the drawing frame memory 118 in step S124, assuming that there are graphics provided on different planes. On the other hand, when the two numbers are the same, the sequence identification number step extracted from the write data 123 is compared with the sequence identification number extracted from the read data 124 in S125. When the sequence identification number step extracted from the write data 123 is larger than the sequence identification number extracted from the read data 124, a pixel is written into the drawing frame memory 118 in step S126. Conversely, when the sequence identification number step extracted from the write data 123 is smaller than the sequence identification number extracted from the read data 124, a write process with respect to the drawing frame memory 118 is omitted in step S127.

Note that a condition in step S125 under which a pixel is written into the drawing frame memory 118, may be that the sequence identification number step extracted from the write data 123 is smaller than the sequence identification number extracted from the read data 124.

Thus, in the case of the method employing plane identification numbers and sequence identification numbers, the same plane can be determined without using the two commands Start and End, so that the process of the commands Start and End can be omitted in the control section 100 and the data format extraction control section 115, resulting in high speed. Further, not all α values are used as sequence identification numbers, resulting in high speed of the data comparing section 113. Furthermore, a plurality of graphics can coexist and can be drawn irrespective of the sequence, thereby making it possible to increase the degree of freedom of arrangement of drawing commands in the control section 100.

The above-described procedure of the drawing processing method is programmed and recorded in a recording medium. The recording medium is read by a computer, so that the procedure is executed by the computer.

What is claimed is:

1. An image processing method for generating graphic drawing data in accordance with a graphic drawing command for image data and storing the graphic drawing data into a drawing frame memory, comprising:
a data format extracting step of extracting a data format suitable for the graphic drawing data to be generated, depending on a graphic drawing command for a graphic to be drawn;
a conversion step of converting write data to be drawn, and read data in the drawing frame memory corresponding to a graphic position of the write data into the extracted data format; and
a drawing omission determining step of determining whether or not the write data and read data converted by the conversion step are the same, and based on the result of the matching determination, determining whether or not a process of writing the write data into the drawing frame memory can be omitted.

2. The image processing method of claim 1, wherein the data format extracting step extracts a data format suitable for the graphic drawing data to be generated, depending on a drawing attribute, a drawing color format or the like designated by a graphic drawing command for a graphic to be drawn.

3. The image processing method of claim 1, wherein the data format extracting step extracts, as the data format, a data format having a drawing attribute which employs only a data included in drawing data, or a data format having a drawing attribute which employs data other than the α data.

4. An image processing method for generating graphic drawing data in accordance with a graphic drawing command for image data and storing the graphic drawing data into a drawing frame memory, comprising:
a data format extracting step of extracting a data format suitable for the graphic drawing data to be generated, depending on a graphic drawing command for a graphic to be drawn;
a conversion step of converting write data to be drawn, and read data in the drawing frame memory corresponding to a graphic position of the write data into the extracted data format; and
a drawing omission determining step of determining whether or not a difference between the write data and read data converted by the conversion step is within a predetermined range, and based on the result of the determination, determining whether or not a process of writing the write data into the drawing frame memory can be omitted.

5. An image processing method for generating graphic drawing data in accordance with a graphic drawing command for image data and storing the graphic drawing data into a drawing frame memory, wherein
drawing data to be drawn includes α data, and a predetermined bit of the α data is used as a sequence identification number, and
the method comprises a drawing omission determining step of, when two or more graphics to be drawn are superposed and drawn on the same plane, comparing a sequence identification number of a pixel to be drawn with a sequence identification number in the drawing frame memory corresponding to a graphic position of the pixel, and based on the result of the comparison, determining whether or not a process of writing data of the pixel into the drawing frame memory can be omitted.

6. The image processing method of claim 5, wherein, when two or more graphics to be drawn are superposed on the same plane, and the graphics are rearranged in order of vertical position with the lowest first before being superposed and drawn, the drawing omission determining step determines whether or not two predetermined graphics overlap, and when the result of the determination shows that the two graphics overlap, determines that one of the graphics can be omitted, based on the sequence identification numbers.

7. An image processing method for receiving a command list for image data, generating graphic drawing data in accordance with a graphic drawing command in the command list, and storing the graphic drawing data into a drawing frame memory, wherein
the command list defines a start command and an end command, and graphics generated by two or more graphic drawing commands provided between the start and end commands are defined to be present on the same plane,
α data included in drawing data for the graphics generated by the graphic drawing commands between the start and end commands is used as sequence identification numbers indicating a graphic superposition sequence, and
the method comprises:
a control step of processing the command list;
a write data extracting step of extracting a sequence identification number of a pixel of a graphic to be drawn which is generated by the graphic drawing command;
a read data extracting step of extracting a sequence identification number in the drawing frame memory having the same coordinates as those of the pixel of the graphics to be drawn; and
a drawing omission determining step of comparing the two extracted sequence identification numbers, and depending on the result of the comparison, determining whether or not a write process with respect to the drawing frame memory can be omitted.

8. An image processing method for receiving a command list for image data, generating graphic drawing data in accordance with a graphic drawing command in the command list, and storing the graphic drawing data into a drawing frame memory, wherein
the command list defines a start command and an end command, and graphics generated by two or more graphic drawing commands provided between the start and end commands are defined to be present on the same plane,
α data included in drawing data for the graphics generated by the graphic drawing commands between the start and end commands is used as sequence identification numbers indicating a graphic superposition sequence, and
the method comprises:
a control step of processing the command list to rearrange the two or more graphic drawing commands in order of vertical position with the lowest or highest first, based on the sequence identification numbers of the two or more graphic drawing commands between the start and end commands; and
a drawing processing step of drawing the graphics based on the graphic drawing commands in accordance with the rearranged sequence of the graphic drawing commands.

9. The image processing method of claim 8, wherein the control step extracts a graphic drawing command located at the highest position, and
the drawing processing step draws only a graphic based on the graphic drawing command located at the highest position.

10. An image processing method for generating graphic drawing data in accordance with a graphic drawing command for image data and storing the graphic drawing data into a drawing frame memory, comprising:
a control step of processing the graphic drawing command when graphics are superposed and drawn, the graphic drawing command having bits of α data included in drawing data as a plane identification number and a sequence identification number;
a write data extracting step of extracting a plane identification number of a pixel of a graphic generated in accordance with the graphic drawing command processed in the control step;
a read data extracting step of extracting a plane identification number in the drawing frame memory having the same coordinates as those of the pixel of the generated graphic; and
a data comparing step of comparing the two extracted plane identification numbers, and depending on the result of the comparison, determining whether or not the two pixels having the two plane identification numbers are of graphics present on the same plane.

11. The image processing method of claim 10, comprising:
a write data extracting step of extracting a sequence identification number of a graphic determined to be present on the same plane;
a read data extracting step of extracting a sequence identification number in the drawing frame memory having the same coordinates as those of the graphic determined to be present on the same plane; and
a drawing omission determining step of comparing the two extracted sequence identification numbers, and depending on the result of the comparison, determining whether or not a write process with respect to the drawing frame memory can be omitted.

12. The image processing method of claim 1, wherein the drawing omission determining step determines whether or not generation of drawing data is invariably performed with respect to the drawing frame memory which has not been drawn, and when the result of the determination is positive, omits reading of data from the drawing frame memory.

13. A program for causing a computer to a procedure for the drawing processing method of claim 1.

14. A computer readable recording medium storing the program of claim 13.
